(19) United States
(12) Patent Application Publication
(10) Pub. No.: US 2018/0014359 A1
(43) Pub. Date: Jan. 11, 2018

(54) HEATING DEVICE, IN PARTICULAR A SEMI-TRANSPARENT HEATING DEVICE

(71) Applicants: COMMISSARIAT A L'ENERGIE ATOMIQUE ET AUX ENERGIES AL TERNATIVES, Paris (FR); CENTRE NATIONAL DE LA RECHERCHE SCIENTIFQUE, Paris Cedex 16 (FR); UNIVERSITE DE NANTES, Nantes Cendex 1 (FR)

(72) Inventors: Jean-Pierre SIMONATO, Sassenage (FR); Alexandre CARELLA, Mazeres-Lezons (FR); Caroline CELLE, Firminy (FR); Abdou DJOUADI, Nantes (FR); Guillaume DROVAL, Sautron (FR); Sylvain SIM, Saint Sebastien Sur Loire (FR)

(21) Appl. No.: 15/545,151

(22) PCT Filed: Jan. 27, 2016
(86) PCT No.: PCT/EP2016/051648

§ 371 Date: Jul. 20, 2017

(30) Foreign Application Priority Data
Jan. 28, 2015 (FR) 1550666

(51) Int. Cl. H05B 3/14; H05B 3/84

(52) U.S. Cl. CPC H05B 3/146; H05B 3/84; H05B 2203/034; H05B 2203/011; H05B 2214/04; H05B 2203/013

(57) ABSTRACT

The present invention relates to a heating device comprising: a base substrate; an electrically conductive layer, referred to as the heating layer, carried by the substrate, formed from at least one percolating network of nano-objects comprising metal nanowires; and a thermal diffusion layer made from aluminum nitride, covering all or part of the heating layer. The invention also concerns a method for preparing such a heating device.

The present invention relates to a novel multilayer heating device based on nanomaterials covered with aluminum nitride.

In particular, such a device may exhibit both good heating properties at low voltage and high transparency, advantageously rendering it suitable for a use thereof as transparent conductive film for heating and/or demisting systems for which a demand for visibility is required.

Transparent conductive heating films are arousing increasing interest for a wide range of applications, for example for display devices, motor vehicle demisting or deicing systems, heated glazings, and the like.

Currently, the techniques for the manufacture of transparent heating films are based on the use of films of transparent conductive oxides (TCOs) and more particularly of indium oxide doped with tin (ITO).

However, the use of these materials exhibits a number of disadvantages, in particular from the viewpoint of the high and fluctuating cost of indium and the high mechanical weakness of ITO. In addition, the techniques of the manufacture of these films are complex, requiring that the process be carried out under vacuum, and are limited to depositions on flat surfaces.

Recent advances in the field of nanotechnologies have made it possible to provide networks of nano-objects, in particular based on metal nanowires, combining good electrical conductivity properties and a high transparency.

Provision is thus to be made, by Celle et al. [1], to produce thin flexible transparent films based on networks of silver nanowires, prepared by spin coating or spray coating techniques, exhibiting both properties of heating at low voltage and of high temperature.

Likewise, Kim et al. [2] have developed hybrid layers of carbon nanotubes and silver nanowires.

Mention may also be made of Zhang et al. [3], who provide a hybrid film architecture based on silver nanowires (AgNWs) and on graphene oxide (rLGO) exhibiting good performances in terms of transparency and of thermal conductivity.

The present invention is targeted at providing a novel multilayer heating device which makes it possible to access a rapid and homogeneous heating of a surface, while exhibiting properties of high transparency.

More specifically, the present invention relates, according to a first of its aspects, to a heating device comprising:
a base substrate;
an electrically conducting layer, referred to as heating layer, carried by the substrate and formed of at least a percolating network of nano-objects comprising metal nanowires; and
a thermal diffusion layer based on aluminum nitride, covering all or part of the heating layer.

To the knowledge of the inventors, it has never been proposed to coat an electrically conducting layer based on nano-objects with aluminum nitride.

In fact, aluminum nitride is normally crystallized by molecular beam epitaxy (MBE) techniques or vapor-phase epitaxy MOCVD (Metal Organic Chemical Vapor Deposition). These techniques require high temperatures, of greater than 950° C., which are incompatible with a surface deposition of metal nanowires, the latter being detrimentally affected at high temperature and liable to lose their structural properties.

The heating device according to the invention proves to be advantageous on several accounts.

First of all, such a device exhibits good low-voltage heating properties and makes it possible to uniformly release the heat produced at the surface of the device.

Thus, as illustrated in the examples which follow, it is possible to achieve, in a very short time, with a heating device according to the invention, a homogeneous temperature over the whole of the exposed surface of the heating device.

Such performance levels are particularly sought for when it is desired to obtain a rapid effect of starting up the heating system, for example in the context of an application of a demisting system, in particular for vehicles.

Furthermore, particularly advantageously, a heating device according to the invention may combine both heating and optical transparency properties, which renders it suitable for the design of various semitransparent and transparent heating and/or demisting systems, for example for glazings, shower panels, spectacles, heating elements of optoelectronic devices, and the like.

More particularly, a heating device according to the invention may exhibit an overall transmittance, over the whole of the visible spectrum, of at least 50%, advantageously of at least 70% and more particularly of at least 80%.

The heating device according to the invention may advantageously be prepared by high-surface-area printing techniques and at low temperature.

More specifically, the present invention relates, according to another of its aspects, to a process for the preparation of a heating device, comprising at least the stages consisting in:

(i) having available a base substrate, one of the faces of which is covered at least in part with an electrically conducting layer, known as heating layer, formed of at least a percolating network of nano-objects comprising metal nanowires; and

(ii) forming, over all or part of the exposed surface of said heating layer, a thermal diffusion layer based on aluminum nitride by high power pulsed or direct current magnetron cathode sputtering, at a temperature of strictly less than 280° C.

Other characteristics, advantages and modes of application of the heating device according to the invention and of its preparation will emerge more clearly on reading the detailed description which will follow, given by way of illustration and without limitation.

In the continuation of the text, the expressions “between . . . and . . . ”, “ranging from . . . to . . . ” and “varying from . . . to . . . ” are equivalent and are intended to mean that the limits are included, unless otherwise mentioned.

Unless otherwise indicated, the expression “comprising a/an” should be understood as “comprising at least one”.

Heating Device

Base Substrate

In the context of the present invention, the term “substrate” refers to a solid base structure, on at least one of the faces of which are formed the heating layer and the thermal diffusion layer.

The base substrate may be of varied natures.

It may be a flexible or rigid substrate. The substrate may be transparent, translucent, opaque or colored.

It is understood that the substrate is appropriately chosen from the viewpoint of the application targeted for the heating device.

In particular, in the case where the heating device has to satisfy optical transparency properties, for example for a motor vehicle demisting/deicing system, transparent glazing, and the like, the substrate is chosen from semitransparent or transparent substrates.

The term “semitransparent” is understood to describe, according to the invention, a structure/layer exhibiting a transmittance, over the whole of the visible spectrum, of greater than or equal to 50%.

The transmittance of a given structure represents the light intensity passing through the structure over the visible spectrum. It may be measured by UV-Vis-IR spectrometry, for example using an integrating sphere on a spectrometer of Varian Cary 5000 type.

The transmittance over the visible spectrum corresponds to the transmittance for wavelengths of between 350 and 800 nm.

The term “transparent” according to the invention describes a structure/layer exhibiting a transmittance of greater than or equal to 80%.

The substrate may thus be a substrate made of glass or of transparent polymers, such as polycarbonate, polyolefins, polyethersulfone, polysulfone, phenolic resins, epoxy resins, polyester resins, polyimide resins, polyetherester resins, polyetheramide resins, poly(vinyl acetate), cellulose nitrate, cellulose acetate, polystyrene, polyurethanes, polyacrylonitrile, polytetrafluoroethylene, polyacrylates, such as polymethyl methacrylate, polyarylate, polyetherimides, polyetherketones, polyetheretherketones, polyvinylidene fluoride, polyesters, such as polyethylene terephthalate or polyethylene naphthalate, polyamides, zirconia or their derivatives.

Preferably, the base substrate may be made of glass or of polyethylene naphthalate.

The substrate may in particular exhibit a thickness of between 500 nm and 1 cm, in particular between 200 μm and 5 mm.

Heating Layer

In the context of the invention, the “heating layer” carried by the base substrate refers to an electrically conducting layer formed of at least a percolating network of nano-objects, nano-objects including at least metal nanowires.

The metal nanowires may more particularly be chosen from silver, gold and/or copper nanowires.

Preferably, the metal nanowires represent at least 40%, in particular at least 60%, of the total weight of the nano-objects of the heating layer.

The heating layer may comprise, besides the metal nanowires, carbon nanotubes and/or graphene, or their derivatives, such as, for example, graphene oxides.

In a first alternative embodiment, the heating layer may be provided in the form of a single layer formed of a percolating network of nano-objects.

According to a specific embodiment, the heating layer may be formed of a percolating network of metal nanowires.

In another alternative embodiment, the heating layer may exhibit a multilayer percolating network.

More particularly, the percolating network of multilayer nano-objects is formed of at least two sublayers of nano-objects having distinct compositions, in particular based on different nano-objects, at least one of the sublayers comprising, indeed even being formed of, metal nanowires.

According to a specific embodiment, at least one of the sublayers, in particular the upper layer, is formed of metal nanowires.

A heating layer comprising at least two types of different nano-objects is subsequently denoted as “hybrid” heating layer.

By way of example, a hybrid heating layer may be composed of a percolating network formed of a first layer of nano-objects, other than metal nanowires, for example carbon nanotubes, and a second layer of metal nanowires.

Advantageously, the heating layer exhibits a transmittance, over the whole of the visible spectrum, of greater than or equal to 50%, in particular of greater than or equal to 70% and more particularly of greater than or equal to 80%.

According to a particularly preferred embodiment, the density of nano-objects of the percolating network of the heating layer according to the invention is between 100 μg/m² and 500 mg/m².

A person skilled in the art is in a position to adjust the density of nano-objects to be employed in order to obtain a percolating and conducting network. This is because, if the network of nano-objects is insufficiently dense, no conduction pathway is possible, and the layer will not be conducting. Starting from a certain density of nano-objects, the network becomes percolating and the charge carriers may be transported over the entire surface of the heating layer.

Advantageously, the heating layer of a device according to the invention exhibits a sheet resistance of less than or equal to 500 ohm/square.

The sheet resistance may be defined by the following formula:

$$R = \frac{ρ}{t} = \frac{1}{σ \cdot t}$$

in which:

t represents the thickness of the conducting layer (in cm),

σ represents the conductivity of the layer (in S/cm) (σ=1/ρ), and

ρ represents the resistivity of the layer (in Ω·cm).

The sheet resistance may be measured by techniques known to a person skilled in the art, for example with a 4-point resistivity meter, for example of Loresta EP type.

Preferably, the heating layer of the device according to the invention exhibits a sheet resistance of less than or equal to 200 ohm/square, preferably of less than or equal to 100 ohm/square and more preferably of less than or equal to 60 ohm/square.

A low electrical resistance makes it possible to improve the heating performance levels, the thermal power dissipated by the heating film being proportional to V²/R (Joule effect), V representing the voltage applied to the terminals of the heating layer (in direct current DC) and R being the resistance of the heating layer from one terminal to the other.

As illustrated in the examples which follow, a heating layer according to the invention thus exhibits good low-voltage heating properties. More particularly, it makes it possible to achieve a temperature of at least 80° C. by applying low voltages, for example voltages of less than 12 V.

Advantageously, as touched on above, the heating layer according to the invention additionally exhibits properties of high transparency.

More particularly, the heating layer advantageously exhibits, over the whole of the visible spectrum, a transmittance of greater than or equal to 50%.

Preferably, the heating layer exhibits a transmittance, over the whole of the visible spectrum, of greater than or equal to 70%, in particular of greater than or equal to 80%.

By way of illustration of the invention, percolating networks combining both properties of high electrical conductivity and of high transparency are presented in the examples which follow.

Thus, a heating layer according to the invention may advantageously combine properties of high electrical conductivity and optical transparency, allowing it to be used to form a semitransparent or transparent heating device, as described in detail in the continuation of the text.

The thickness of the heating layer of a heating device according to the invention may be between 1 nm and 10 μm, in particular between 5 nm and 800 nm.

Preparation of the Heating Layer

The nano-objects may be prepared beforehand according to methods of synthesis known to a person skilled in the art.

For example, silver nanowires may be synthesized according to the method of synthesis described in the publication Nanotechnology, 2013, 24, 215501 [4]. Copper nanowires may be obtained by the method described in the publication Nano Research, 2014, pp 315-324 [5].

Carbon nanotubes may be mono and/or multiwall, purified or unpurified and functionalized or nonfunctionalized nanotubes. They may be obtained according to known techniques, for example by laser ablation, CVD or arc discharge.

The percolating network may be obtained by deposition at the surface of the base substrate of one or more suspensions of nano-objects in a solvent medium (water, methanol, isopropanol, and the like), followed by the evaporation of the solvent or solvents.

More particularly, metal nano-objects may be dispersed beforehand in an organic solvent which can be easily evaporated (for example methanol or isopropanol) or also dispersed in an aqueous medium in the presence of a surfactant.

The suspension of nano-objects may subsequently be deposited at the surface of the substrate according to the methods known to a person skilled in the art, the most widely used techniques being spray coating, inkjet coating, dip coating, film drawer coating, impregnation coating, scraper coating, flexographic coating, and the like.

According to a specific embodiment, the heating layer is formed by spray coating one or more suspensions of the nano-objects in a solvent medium, followed by the evaporation of the solvent or solvents.

The solvent or solvents of the suspension of nano-objects are subsequently evaporated in order to form a percolating network of nano-objects making possible the passage of the current.

In order to further improve the performance levels of the electrically conducting material, the network of nano-objects, for example nanowires, may be annealed at a temperature of between 100 and 150° C.

As described above, the percolating network of the heating layer of a device according to the invention may be composed of several layers of superimposed nano-objects. In this case, the stages of deposition of the suspension of nano-objects and evaporation of the solvent are repeated as many times as desired to obtain layers of nano-objects.

Thermal Diffusion Layer

As specified above, the heating layer is coated in all or part with a layer of aluminum nitride (AlN), known as “thermal diffusion layer”.

Aluminum nitride films exhibit properties which are particularly advantageous in terms of electrical insulation and of thermal conductivity, depending on their crystalline quality.

Preferably, the AlN layer covers all of the heating layer.

According to a particularly preferred embodiment, a thermal diffusion layer according to the invention exhibits a thermal conductivity of greater than or equal to 20 W·K⁻¹·m⁻¹, in particular between 80 and 250 W·K⁻¹·m⁻¹.

The thermal conductivity gives the ability of a material to dissipate heat. It may be measured by a technique of transient hot-strip type.

Such a thermal diffusion layer makes it possible to release the heat produced by the underlying heating layer, uniformly over the entire exposed surface of the heating device.

Advantageously, the superimposition according to the invention of a heating layer exhibiting a low sheet resistance and of a thermal diffusion layer having high thermal conductivity makes it possible to access, in a very short time, uniform heating of the whole of the surface of the heating device.

Such a device is particularly advantageous for applications of heating systems, for example motor vehicle demisting/deicing systems, for which it is desired to obtain a rapid effect of starting up the heating system.

Preferably, the thermal diffusion system exhibits a thickness of between 50 nm and 5 μm, in particular between 80 nm and 800 nm.

The AlN layer according to the invention advantageously exhibits a high transparency.

In particular, the AlN layer exhibits a transmittance, over the whole of the visible spectrum, of greater than or equal to 50%, in particular of greater than or equal to 70% and more particularly of greater than or equal to 80%.

Preparation of the Thermal Diffusion Layer

The inventors are taking advantage of recent optimizations of magnetron cathodic sputtering deposition techniques to access, at low temperature, a thin AlN film of good crystalline quality exhibiting a good thermal conductivity.

Thus, the thermal diffusion layer of a device according to the invention may be formed, at the surface of the percolating network of nano-objects, by continuous mode DC magnetron cathode sputtering or high power impulse magnetron sputtering (HiPIMS).

The technique for deposition of a thin film on a substrate by magnetron cathode sputtering consists, generally, in bombarding a target, which forms the cathode of a magnetron reactor and which is made of the material to be deposited, with ions resulting from an electric discharge (plasma). This ion bombardment brings about the sputtering of the target in the form of a “vapor” of atoms or molecules, which atoms or molecules will be deposited, in the form of a thin layer, on the substrate placed close to the target of the magnetron.

The HiPIMS technology advantageously makes it possible to generate very high instantaneous currents while maintaining reduced heating of the target as a result of the use of short-duration pulses.

These advanced magnetron sputtering methods are, for example, described by Belkerk et al. [6] and Duquenne et al. [7].

A thin AlN layer of good crystallinity may more particularly be produced by magnetron sputtering starting from an aluminum target and from a reactive argon/nitrogen mixture.

It may be formed at a temperature strictly less than 280° C., not affecting the stability of the underlying heating layer.

Preferably, it is formed at a temperature of less than or equal to 250° C. and more particularly of less than or equal to 200° C.

Applications

As touched on above, the multilayer heating device according to the invention may, advantageously, have both good heating performance levels and a high transparency.

According to a particularly preferred alternative embodiment, the invention relates to a semitransparent or transparent heating device, comprising:
a semitransparent or transparent base substrate, in particular as defined above, for example made of glass or of transparent polymer;
a heating layer exhibiting a transmittance, over the whole of the visible spectrum, of greater than or equal to 50%, in particular of greater than or equal to 70% and more particularly of greater than or equal to 80%; and
a thermal diffusion layer based on aluminum nitride covering all or part of the heating layer.

Advantageously, a heating device according to the invention may exhibit an overall transmittance over the whole of the visible spectrum of at least 50%, in particular of greater than or equal to 70% and more particularly of greater than or equal to 80%.

“Overall” transmittance is understood to mean the transmittance of the combined structure formed by the substrate, heating layer and thermal diffusion layer stack according to the invention.

A heating device according to the invention may be employed as a thin transparent heating film for various applications, in particular in heating and/or demisting systems.

A person skilled in the art is in a position to adjust the shape and the dimensions of the heating device according to the invention in order to incorporate it in the desired heating system.

The heating device according to the invention may be used by application of a voltage between two opposite edges of the heating layer.

Thus, according to a specific embodiment, two nontransparent conducting strips may be deposited on the base substrate, in contact with two opposite edges of the heating layer, as represented in FIG. 1.

These strips, known as “contact pads”, may, for example, be produced from metal paste or silver lacquer, in order to make possible a better connection with external power supply systems.

These electrical contact pads may be produced according to ordinary techniques, for example by chemical vapor deposition (CVD) or by physical vapor deposition (PVD).

The power supply for the system incorporating a heating device may be permanent or mobile, for example a battery or a photovoltaic cell, and be fed continuously or non-continuously.

According to another of its aspects, the present invention thus relates to a heating and/or demisting system comprising a heating device as described above, in particular a semitransparent or transparent heating device.

Generally, the heating and/or demisting system may relate to any type of known system of the state of the art requiring the use of a heating film, in particular at high temperature.

The system may be employed, for example, for a glazing, a shower panel, a mirror industry element, a visor, a mask, spectacles, a radiator, a heating element of an optoelectronic device or a transparent food container, for example a baby's bottle.

By way of example, a heating device according to the invention, produced with a flexible and transparent base substrate, may be employed for a transparent heating element (transparent electrode) in an optoelectronic device, for example a display screen.

A heating and semitransparent device according to the invention may also be employed for a heating windshield, the heating device being intended to heat the windshield for the purpose of demisting it or deicing it. The performance levels of the heating device according to the invention in terms of heating and of high temperature make it possible to rapidly access, in the context of an application for a motor vehicle windshield, a clear view, after activation of the heating device.

Of course, the invention is not limited to the systems described above and other applications to the heating device according to the invention may be envisaged.

The invention will now be described by means of the following examples and figures, given by way of illustration and without implied limitation of the invention.

### FIGURES

FIG. 1: Diagrammatic representation, in a vertical sectional plane, of the structure of a heating device (1) in accordance with the invention.

FIG. 2: Diagrammatic view of the application of a voltage using a voltage generator (22) to the contact pads of a device (1) in accordance with the invention, as carried out in examples 1 to 4.

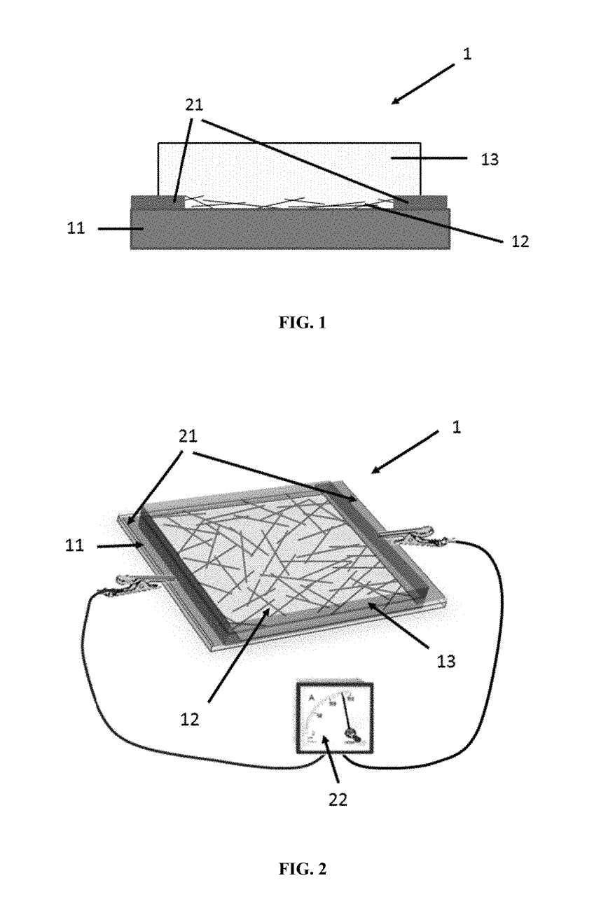

It should be noted that, for reasons of clarity, the different elements visible in the figures are not represented to scale, the true dimensions of the different parts not being observed.

### EXAMPLES

Measurement Methods

The total transmittance is measured using an integrating sphere on a Varian Cary 5000 spectrometer.

The transmittance over the visible spectrum corresponds to the transmittance for wavelengths of between 350 and 800 nm. The transmittance is measured every 2 nm.

The electrical sheet resistance is measured with a 4-point resistivity meter of Loresta EP type.

### Example 1

Formation of the Heating Layer (12)

In a first step, silver nanowires are synthesized and purified according to the process described in the document Nanotechnology, 2013, 24, 215501 [4].

These nanowires are deposited on Eagle XG™ glass (Corning) (substrate (11)) according to a spray coating process.

The material thus deposited, constituting the heating layer (12), exhibits a sheet resistance of 28 ohm/square.

Electrical contact pads (21) are produced on two opposite edges by use of a silver lacquer or of a deposition of metal film, for example by CVD or PVD.

Formation of the Thermal Diffusion Layer (13)

The aluminum nitride (AlN) is deposited on this heating layer (12) by direct current magnetron sputtering. During this deposition, the electrical contact pads are protected in order to be subsequently used in order to apply a potential to the device.

The deposition by direct current magnetron sputtering is carried out starting from a pure aluminum target and from an argon and nitrogen plasma under high vacuum (pressure of between 2 and 3 mTorr) and at low temperature (T=200° C.). The power used is 175 W. The ratio of the amounts of nitrogen and argon AN₂/(AN₂+AAr) is 25%.

Under these conditions, the rate of deposition is approximately 40 nm/min, which makes possible precise control of the thickness of the AlN layer deposited.

The deposition is carried out for 5 minutes, which makes it possible to obtain a layer (13) of 200 nm.

On applying a voltage of 5 V to the contact pads, a temperature of 35° C. is achieved in less than one minute, homogeneously over the whole of the surface of the heating device (1).

This heating device (1) has an overall transmittance, measured using an integrating sphere on a Varian Cary 5000 spectrometer, of a minimum of 85% over the whole of the visible spectrum.

On applying a voltage of 7 V to the contact pads, a temperature of 51° C. is achieved in less than one minute, homogeneously over the whole of the surface of the heating device.

### Example 2

Formation of the Heating Layer (12)

In a first step, carbon nanotubes (CSP3 type from Carbon Solution) are dispersed in NMP (N-MethylPyrrolidone) and deposited on Eagle XG™ glass (Corning) according to a spray coating process. The transmittance of the deposited layer, over the whole of the visible spectrum, is 99.2%.

Silver nanowires are synthesized and purified according to the process described in the document Nanotechnology, 2013, 24, 215501. These nanowires are deposited on the layer of carbon nanotubes.

The “hybrid” heating layer (12), composed of the two sublayers of nanomaterials of different natures, thus formed exhibits a sheet resistance of 20 ohm/square.

Electrical contact pads (21) are produced on two opposite edges by use of a silver lacquer or of deposition of metal film, for example by CVD.

Formation of the Thermal Diffusion Layer (13)

The aluminum nitride (AlN) is deposited on this heating layer as described in example 1.

On applying a voltage of 5 V to the contact pads (21), a temperature of 45° C. is achieved in less than one minute, homogeneously over the whole of the surface of the heating device (1).

This device (1) has an overall transmittance of a minimum of 88% over the whole of the visible spectrum.

### Example 3

A heating device (1) similar to that described in example 1 is produced, employing, in place of the silver nanowires, copper nanowires manufactured according to the process described in the publication Nano Research, 2014, pp 315-324 [5].

The heating layer (12) thus produced exhibits a sheet resistance of 53 ohm/square.

The deposition of AlN is carried out as described in example 1.

On applying a voltage of 9 V to the contact pads, a temperature of 63° C. is achieved in less than one minute, homogeneously over the whole of the surface of the heating device.

This device has an overall transmittance of a minimum of 82% over the whole of the visible spectrum.

### Example 4

A heating device (1) similar to that described in example 1 is produced, employing, in place of the glass substrate, a substrate (11) made of polyethylene naphthalate with a thickness of 125 μm.

The heating layer (12) thus produced exhibits a sheet resistance of 19 ohm/square.

The deposition of AlN is carried out as described in example 1.

On applying a voltage of 9 V to the contact pads, a temperature of 71° C. is achieved under stationary conditions, homogeneously over the whole of the surface of the heating device.

This device has an overall transmittance of a minimum of 90% over the whole of the visible spectrum.

### REFERENCES

[1] Celle et al., “Highly Flexible Transparent Film Heaters Based on Random Networks of Silver Nanowires”, Nano Research (2012), 5(6), 427-433;
[2] Kim et al., “Transparent flexible heater based on hybrid of carbon nanotubes and silver nanowires”, Carbon, 63 (2013), 530-536;
[3] Zhang et al., “Large-size graphene microsheets as a protective layer for transparent conductive silver nanowire film heaters”, Carbon, 69 (2014), 437-443;
[4] Nanotechnology, 2013, 24, 215501;
[5] Nano Research, 2014, pp 315-324;
[6] Belkerk et al., “Structural-dependent thermal conductivity of aluminum nitride produced by reactive direct current magnetron sputtering”, Appl. Phys. Lett., 101, 151908 (2012);
[7] Duquenne et al., Appl. Phys. Lett., 93, 052905 (2008).

1. A heating device comprising:
a base substrate;
an electrically conducting layer, referred to as heating layer, carried by the substrate, formed of at least a percolating network of nano-objects comprising metal nanowires; and
a thermal diffusion layer based on aluminum nitride, covering all or part of the heating layer.

2. The device as claimed in claim 1, in which the heating layer exhibits a transmittance, over the whole of the visible spectrum, of greater than or equal to 50%.

3. The device as claimed in claim 1, in which the heating layer exhibits a sheet resistance of less than or equal to 500 ohm/square.

4. The device as claimed in claim 1, in which the metal nanowires represent at least 40% by weight, of the total weight of the nano-objects of said heating layer.

5. The device as claimed in claim 1, in which the metal nanowires are chosen from silver, gold and/or copper nanowires.

6. The device as claimed in claim 1, in which the heating layer comprises, besides the metal nanowires, carbon nanotubes and/or graphene, or their derivatives.

7. The device as claimed in claim 1, in which the percolating network of nano-objects of the heating layer exhibits a density of nano-objects of between 100 μg/m² and 500 mg/m².

8. The device as claimed in claim 1, in which the heating layer is provided in the form of a single layer formed of a percolating network of nano-objects.

9. The device as claimed in claim 1, in which the heating layer exhibits a multilayer percolating network formed of at least two sublayers of nano-objects having distinct compositions, at least one of the sublayers comprising, indeed even being formed of, metal nanowires.

10. The device as claimed in claim 1, in which the heating layer exhibits a thickness of between 1 nm and 10 μm.

11. The device as claimed in claim 1, in which the thermal diffusion layer exhibits a thermal conductivity of greater than or equal to 20 W·K⁻¹·m⁻¹.

12. The device as claimed in claim 1, in which the thermal diffusion layer exhibits a thickness of between 50 nm and 5 μm.

13. The device as claimed in claim 1, in which the thermal diffusion layer covers all of the heating layer.

14. The device as claimed in claim 1, in which the base substrate is a transparent or semitransparent substrate.

15. The device as claimed in claim 1, which is semitransparent or transparent, in which:
the base substrate is semitransparent or transparent, in particular as defined in claim 14; and
the heating layer exhibits a transmittance, over the whole of the visible spectrum, of greater than or equal to 50%.

16. The device as claimed in claim 15, characterized in that it exhibits an overall transmittance, over the whole of the visible spectrum, of at least 50%.

17. A process for the preparation of a heating device, comprising at least the stages consisting in:
(i) having available a base substrate, one of the faces of which is covered at least in part with an electrically conducting layer, known as heating layer, formed of at least a percolating network of nano-objects comprising metal nanowires; and
(ii) forming, over all or part of the exposed surface of said heating layer, the thermal diffusion layer based on aluminum nitride by high power pulsed or direct current magnetron cathode sputtering, at a temperature of strictly less than 280° C.

18. The process as claimed in claim 17, in which the thermal diffusion layer is formed in stage (ii) at a temperature of less than or equal to 250° C.

19. The process as claimed in claim 17, in which the heating layer carried by the substrate of stage (i) is formed beforehand by spray coating one or more suspensions of the nano-objects in a solvent medium, followed by the evaporation of the solvent or solvents.

20. A heating and/or demisting system, comprising a heating device as defined according to claim 1.

21. The system as claimed in claim 20, comprising a transparent or semitransparent heating device as defined in claim 15, said system being employed for a glazing, a shower panel, a mirror industry element, a visor, a mask, spectacles, a radiator, a heating element of an optoelectronic device or a transparent food container.

22. The device as claimed in claim 1, in which the metal nanowires represent at least 60% of the total weight of the nano-objects of said heating layer.

23. The device as claimed in claim 1, in which the heating layer is provided in the form of a percolating network of metal nano wires.

24. The device as claimed in claim 1, in which the heating layer exhibits a thickness of between 5 nm and 800 nm.

25. The device as claimed in claim 1, in which the base substrate is made of glass or of transparent polymers, selected from polycarbonate, polyolefins, polyethersulfone, polysulfone, phenolic resins, epoxy resins, polyester resins, polyimide resins, polyetherester resins, polyetheramide resins, poly(vinyl acetate), cellulose nitrate, cellulose acetate, polystyrene, polyurethanes, polyacrylonitrile, polytetrafluoroethylene, polyacrylates, selected from polymethyl methacrylate, polyarylate, polyetherimides, polyetherketones, polyetheretherketones, polyvinylidene fluoride, polyesters, selected from polyethylene terephthalate or polyethylene naphthalate, polyamides, zirconia or their derivatives.
